(19) United States
(12) Patent Application Publication
(10) Pub. No.: US 2010/0023622 A1
(43) Pub. Date: Jan. 28, 2010

(54) METHOD FOR ASSIGNING RESOURCE OF UNITED SYSTEM

(75) Inventors: Kyung Sook Kim, Daejeon (KR); Sook Yang Kang, Daejeon (KR); Gyung Chul Shin, Daejeon (KR); Jin Up Kim, Daejeon (KR); Kil Su Hong, Busan (KR); Jung Min Lee, Kyung-ki Do (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/180,265

(22) Filed: Jul. 25, 2008

(51) Int. Cl. G06F 15/173

(52) U.S. Cl. 709/226

(57) ABSTRACT

A method of assigning a resource of a united system in which a plurality of single systems are complexly operated includes: determining a cost function using standard network state information commonly used within the united system; and assigning a resource based on the cost function. Therefore, a state of each system and user requirements can be fully reflected and a resource can be efficiently managed within a united system in which several systems are complexly operated.

### CROSS-REFERENCE TO RELATED APPLICATION

1. This application claims the benefit of Korean Application No. 2007-0132819, filed on Dec. 17, 2007 in the Korean Intellectual Property Office, the disclosure of which is incorporated herein by reference.

### BACKGROUND OF THE INVENTION

1. Field of the Invention

This work was supported by the IT R&D program of MIC/IITA. [2006-S003-02, Research on service platform for the next generation mobile comm.]

The present invention relates to a method of assigning a resource of a united system, and more particularly, to a method of assigning a resource of a united system that can effectively connect systems and users by fully reflecting a state of each system and requirements of users and efficiently managing a resource within a united system in which several systems are complexly operated.

2. Description of the Related Art

Nowadays, as wireless Internet (WiBro) is regularly commercially used, a concern about next generation mobile communication technology has increased and a research thereof has been actively performed.

As a form of next generation mobile communication, a form of connecting to existing systems such as WiBro, CDMA, WLAN and a form of developing a new system such as universal air-interface technology while researching and developing in WG4 under a FuTURE forum and a wireless world research forum (WWRF) of China are currently considered.

In both the form of connecting to existing systems and the form of developing a new system, in order to ensure backward compatibility, it is inevitable to integrally operate the new system and the existing system and as essential technology for this, a radio resource management technique through vertical handover may be used.

FIGS. 1A and 1B are diagrams illustrating an exemplary embodiment of a united system.

Referring to FIGS. 1A and 1B, FIG. 1A shows a united system that operates in a central concentration scheme by a system supervisor for managing an entire system and FIG. 1B shows a united system in which several systems exchange information and that operates in a distribution scheme.

In such a united system environment, different single systems such as WiBro, CDMA, and WLAN are integrally operated. Conventionally, a great deal of effort for effectively connecting several different systems has been made, but has not been systematically made. For example, requirements between each system and users were not fulfilled, even if requirements between each system and users are fulfilled, only several information was exchanged. Accordingly, the united system was insensitive to a sequentially changing channel state and thus could not reflect user request changing in real time. Further, a service fee that receives from the user was determined according to user request as a service has not reflected a channel state of each system.

### SUMMARY OF THE INVENTION

The present invention has been made in an effort to solve the above problems, and the present invention provides a method of assigning a resource of a united system that can fully reflect a state of each system and requirements of users and efficiently manage a resource within a united system in which several systems are complexly operated.

According to an aspect of the present invention, there is provided a method of assigning a resource of a united system in which a plurality of single systems are complexly operated, including: determining a cost function using standard network state information commonly used within the united system; and assigning a resource based on the cost function.

According to another aspect of the present invention, there is provided a method of assigning a resource of a united system in which a plurality of single systems are complexly operated, including: determining standard network state information commonly used within the united system; and assigning a resource based on the standard network state information.

According to another aspect of the present invention, there is provided a method of assigning a resource of a united system in which a plurality of single systems are complexly operated, including: exchanging state information of each system and request information of each user; and assigning a resource based on the state information and the request information.

### BRIEF DESCRIPTION OF THE DRAWINGS

FIGS. 1A and 1B are diagrams illustrating an exemplary embodiment of a united system;

FIGS. 2A to 2B are diagrams illustrating an example in which a radio resource efficiency is considered under a united system;

FIG. 3 is a diagram illustrating an opportunistic scheduling technique;

FIG. 4 is a diagram illustrating standard network state information according to an exemplary embodiment of the present invention; and

FIG. 5 is a flowchart illustrating a method of assigning a resource of a united system according to an exemplary embodiment of the present invention.

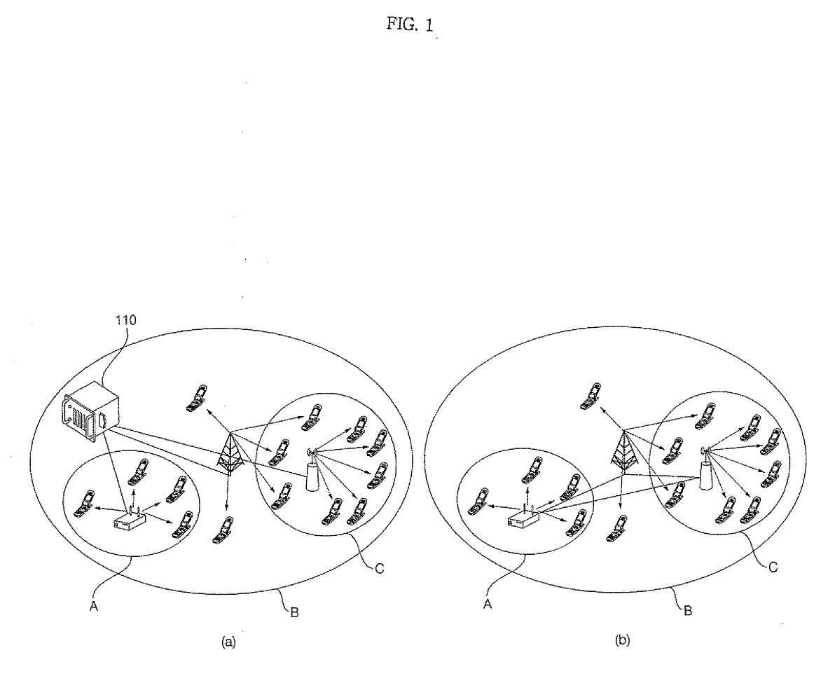

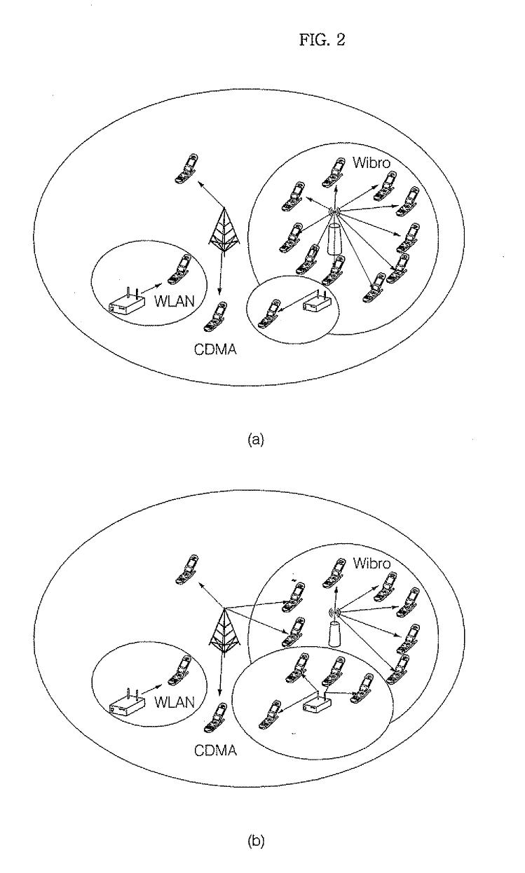

### DETAILED DESCRIPTION OF THE PREFERRED EMBODIMENTS

Exemplary embodiments of the present invention will be described in detail hereinafter with reference to the accompanying drawings.

FIGS. 2A to 2B are diagrams illustrating an example in which a radio resource efficiency is considered under a united system.

A resource management technique in a united system should consider a resource efficiency of an entire united system as well as a resource efficiency of a single system. For example, when only a radio resource efficiency of a single system is considered, a radio resource efficiency can be improved through opportunistic scheduling, however as in FIG. 2A, in a viewpoint of a united system, enlargement of a radio resource efficiency of each single system may not cause enlargement of a radio resource efficiency of an entire united system. Therefore, as in FIG. 2B, it is necessary to manage a radio resource of a united system through cooperation between systems.

In order to achieve cooperation between systems, a common form that can be well used in all systems is necessary. However, a wireless broadband Internet (Wibro) system, a wireless LAN (WLAN) system, a code division multiple access (CDMA) system, a 3GPP-LTE system, a universal mobile telecommunications systems (UMTS), etc. use a radio resource with a different method. For example, when it is assumed that a united system consisting of the CDMA system and the WLAN system is operated through cooperation between systems, the CDMA system transmits information such as transmission electric power and a spreading coefficient by a code to the WLAN system, however in the WLAN system, important elements for determining a transmission efficiency are the quantity of collisions of users and a standby time period due to random backoff. Therefore, transmission of a different index may confuse cooperation between systems.

For this, in the present invention, standard network state information (SNSI) for representing a current state of all systems regardless of a specific system is defined.

In the present invention, it is assumed that overhead about information in which all systems exchange is small enough to ignore. A serving station that exchanges several control information and data with a terminal is called a base station regardless of a system.

Further, it is assumed that each terminal receives data from only one base station that is evenly distributed within a cell and that belongs to one system, or transmits data to only one base station. That is, each terminal cannot simultaneously receive data from a base station of a system A and a base station of a system B.

Further, it is assumed that the terminal is operated in a multi-mode that can perform vertical handover that changes a communication target from a specific system to another system and overhead according to the multi-mode does not exist. When a system in which a terminal communicates is determined, the system assigns a resource to the terminal. In this case, assignment of a resource is independently performed on a system basis. When assigning a resource to the terminal, an opportunistic scheduling technique that assigns a resource from the best channel of each terminal is applied.

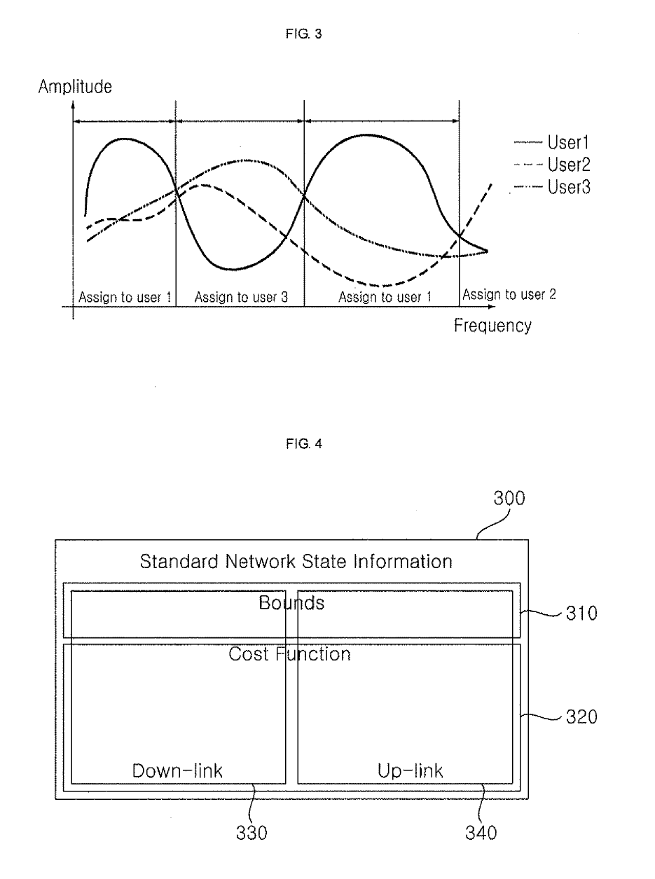

FIG. 3 is a diagram illustrating an opportunistic scheduling technique.

Referring to FIG. 3, a resource is assigned to a user 1 in a first segment, to a user 3 in a second segment, and to a user 1 in a third segment.

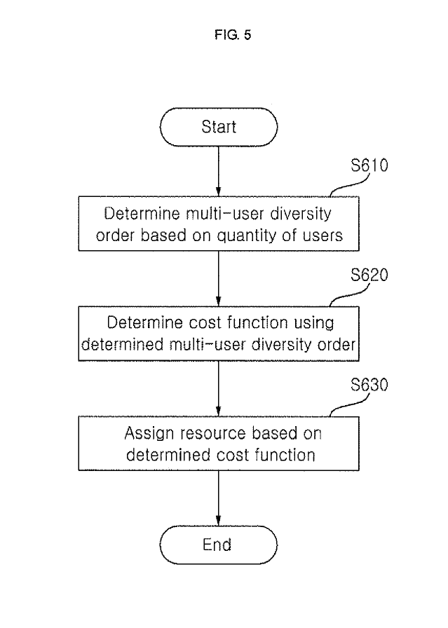

FIG. 4 is a diagram illustrating SNSI according to an exemplary embodiment of the present invention.

Referring to FIG. 4, the SNSI according to an exemplary embodiment of the present invention is largely divided into a service quality (QoS) portion and a cost function portion.

Because each of the service quality (QoS) portion and the cost function portion may be divided into two of a forward link and a backward link, the service quality (QoS) portion and the cost function portion are finally divided into four portions. However, it is unnecessary to distinguish all systems into a forward link and a backward link. As a representative example, in a WLAN system, because a forward link and a backward link are not distinguished, it is unnecessary to divide the WLAN system into a forward link and a backward link.

The service quality (QoS) portion notifies requirements of each user and a state of each system. The service quality (QoS) portion includes a traffic descriptor and a server descriptor.

In the service quality (QoS) portion, both a forward link and a backward link thereof are divided into a leaky bucket model of the traffic descriptor and a latency rate model of the server descriptor.

Characteristics of the traffic descriptor are determined by three conditions of a peak rate, a sustainable rate, and a maximum bust size.

A rate indicates a data amount or a traffic amount per unit time, a peak rate indicates a maximum transmission rate, and a sustainable rate indicates an average transmission rate for a long time. A maximum bust size indicates a total data amount when traffic occurs in a peak rate.

Characteristics of the server descriptor are determined by two conditions of a maximum sustainable service rate and minimum latency. The minimum latency indicates a delay time taken until a server provides a service, and the maximum sustainable service rate indicates an average service rate providing after a server starts a service after minimum latency.

Here, an important point is that a system satisfying conditions such as a maximum delay, a peak rate, a sustainable rate, and a maximum bust size requested by the user may be not one but several. By increasing a maximum sustainable service rate although minimum latency is great or by decreasing minimum latency although a maximum sustainable service rate is small (should be greater than a sustainable rate of the user), several kinds of service providing patterns in which a maximum delay is identical may exist.

The cost function portion is a portion that collects data necessary for calculating a cost function and may be also divided into a forward link cost and a backward link cost, as in the service quality (QoS) portion.

Each of the forward link cost and the backward link cost includes a resource cost and call state adjustment. Here, the resource cost is a cost of a resource required in a process in which a system provides a service and is the quantity of channels in most cases. However, the resource cost is an average concept, may be changed according to a connection state of each user or an actual channel state, and may be adjusted by call state adjustment.

Enlargement of a radio resource efficiency in a united system can be maximized by distributing a load between single systems as well as a single system included in the united system. When a system load is concentrated to a specific system, as in FIG. 2A, because a radio resource is unbalanceably used and service quality (QoS) satisfaction of users and a system capacity are inevitably damaged. However, as in FIG. 2B, when distributing terminals concentrated to specific traffic to a system having relatively many idle radio resources through vertical handover by a suitable principle, an entire radio efficiency of the united system will increase. Therefore, it is a core point in radio resource management of a united system to set a suitable reference for determining a connection system of each terminal.

In order to calculate a cost in which an amount of radio resources using when one terminal is connected to a specific system, a channel state of the terminal, and satisfaction of a service quality (QoS) requested by the terminal are comprehensively considered, the present invention suggests a cost function for quantitatively obtaining the cost.

A cost in the present invention is defined, when a specific system receives any user, as an amount of resources in which the system additionally uses. A cost function indicates a resource amount calculated to an actual numerical value. Therefore, a user can know a cost that should be paid in order to receive a specific service through a cost function.

Here, a cost may be an absolute actual cost and may be used as a relative index representing that a system having a low cost function value is a good system. In other words, a cost function is an index for grasping a state of each system by collecting SNSI and for determining that it is efficient to connect which system and which user by reviewing user requirements.

Further, the cost function performs a function of balancing single systems within a united system in addition to determining each connection. When users are concentrated to a specific single system, by increasing an expense, the cost function distributes users to other systems. That is, the cost function performs a function of sustaining a stable united system state by distributing a load to other systems when an overload is applied to one kind of system.

Finally, a cost function is determined in order to perform a function of balancing single systems as well as connecting systems and a resource is assigned according to the determined cost function. For example, as a value of the cost function decreases, a resource is preferentially assigned.

The cost function is defined by Equation 1 based on the above contents.

$$Cost = \frac{{S}_{avg}}{{A}_{cal}} [ {C}_{BW} ( {M}_{γμ} = \frac{d γ}{d μ} ) \frac{{R}_{req}}{{B}_{sys}} + {D}_{res} ( {L}_{max} - {L}_{req} ) ] \qquad [ Equation 1 ]$$

In parameters of Equation 1, ‘S_{avg}’ indicates an average channel state within a single system, ‘A_{cal}’ indicates a state of a specific channel to which a user belongs, ‘C_{BW}’ indicates a total resource cost, ‘M_{γμ}’ indicates an amount of radio resources using when the terminal additionally transmits unit data, ‘R_{req}’ indicates a sustainable service rate that should receive from a server in order to satisfy a service quality (QoS) condition requested by the user, ‘B_{sys}’ indicates an total bandwidth of the system, ‘Dᵣₑₛ’ indicates a resource reservation cost, ‘Lₘₐₓ’ indicates maximum system latency, and ‘L_{req}’ indicates user request latency.

Here, ‘S_{avg}, A_{cal}, C_{BW}, M_{γμ}, B_{sys}, and Dᵣₑₛ’ are SNSI related to the cost function portion of FIG. 4, and ‘R_{req}, Lₘₐₓ, and L_{req}’ are SNSI related to the service quality (QoS) portion of FIG. 4.

Further, ‘S_{avg}, A_{cal}, C_{BW}, M_{γμ}, B_{sys}, Dᵣₑₛ, and Lₘₐₓ’ are SNSI related to a network (system), and ‘R_{req} and L_{req}’ are SNSI related to an application.

In the cost function of Equation 1, ‘Dᵣₑₛ (Lₘₐₓ-L_{req})’ is a portion related to reservation of latency.

For example, when a user requires a value smaller than maximum system latency presented by a system, although the value may be reduced through reservation, a cost for reducing the value should be additionally paid.

‘Dᵣₑₛ’ is a cost per unit time for reducing a resource reservation cost, i.e. latency. As ‘Dᵣₑₛ’, which is a cost for reducing latency increases, a value of the cost function increases.

Further, ‘(Lₘₐₓ-L_{req})’ is an index for determining an amount of latency to reduce. As latency L_{req} requested by the user increases, latency (Lₘₐₓ-L_{req}) to reduce decreases and thus a value of the cost function decreases. Further, as latency L_{req} requested by the user decreases, latency (Lₘₐₓ-L_{req}) to reduce increases and thus a value of the cost increases.

However, in the cost function, because an influence of a ‘Dᵣₑₛ (Lₘₐₓ-L_{req})’ portion is slight, ‘Dᵣₑₛ (Lₘₐₓ-L_{req})’ may be omitted.

Therefore, the cost function is represented by Equation 2.

$$Cost = \frac{{S}_{avg}}{{A}_{cal}} [ {C}_{BW} ( {M}_{γμ} = \frac{d γ}{d μ} ) \frac{{R}_{req}}{{B}_{sys}} ] \qquad [ Equation 2 ]$$

‘S_{avg}’ indicates an average channel state of several terminals existing within a cell. In a case where several terminals exist within a cell, when it is assumed that several terminals conceptionally exist in an identical distance from a base station, ‘S_{avg}’ is defined as an average radio channel state between the base station and each terminal. ‘S_{avg}’ is calculated by Equation 3.

$${S}_{avg} = \frac{μ}{γ} \qquad [ Equation 3 ]$$

Here, ‘μ’ indicates a resource efficiency of a system, and ‘γ’ indicates a resource use rate of a system. That is, ‘γ’ is an efficiency of a channel side of a system and ‘μ’ is a bandwidth efficiency of a system.

By measuring a data amount in which a base station currently transmits and dividing the data amount by a total resource amount, the bandwidth efficiency μof a system is obtained, and the resource use rate γ of a system is obtained by dividing a resource amount using in a base station by an entire resource. The resource use rate γ of a system and the bandwidth efficiency μ of the system is represented by Equation 4.

$$γ = \frac{{R}_{used}}{{R}_{all}} , μ = \frac{{T}_{sys}}{{B}_{sys}} \qquad [ Equation 4 ]$$

R_{used}: an amount of a currently using resource

Rₐₗₗ: a total resource amount of a system

T_{sys}: data throughput of a current system

B_{sys}: total bandwidth of a system

Because an average channel state S_{avg} is equally applied to all terminals, the average channel state S_{avg} cannot reflect a channel state of an individual terminal scattered within a cell. Therefore, a parameter A_{cal} reflecting a channel state of each terminal is defined.

That is, when a specific terminal exists within a cell, ‘A_{cal}’ is defined by a ratio of a channel state of the specific terminal to the average channel state ‘S_{avg}’. For example, when a channel state of a specific terminal is not better than an average channel state within a cell, a value A_{cal} decreases, and thus a value of the cost function when connecting to the corresponding system increases. When a channel state of a specific terminal is better than an average channel state within a cell, a value A_{cal} increases, and thus a value of the cost function when connecting to the corresponding system decreases.

‘C_{BW}’ indicates a total resource cost. As the total resource cost C_{BW} increases, a value of the cost function increases.

‘B_{sys}’ indicates a total bandwidth of a system and may have a different value in each single system.

A parameter M_{γμ} indicates an amount of radio resources using when a terminal additionally transmits unit data and is very important in the cost function. M_{γμ} is obtained by calculating

$$\frac{d γ}{d μ} .$$

In a radio system having a different channel state, as in FIG. 3, when using an opportunistic scheduling technique, for example, i) when sending 10 data, 3 channels may be necessary, ii) when sending 20 data, 9 channels may be necessary, and iii) when sending 30 data, 16 channels may be necessary. In the examples, values of ‘γ’ and ‘μ’ are as follows. At i), γ=0.03 and μ=0.1, at ii), γ=0.09 and μ=0.2, and at iii), γ=0.16 and μ=0.3. As a value μ increases at i), ii), and iii), a value γ gradually increases. That is, a value of dγ/dμ gradually increases. Accordingly, a value of the cost increases.

Each of various systems such as Wibro, WLAN, CDMA, 3GPP-LTE, and UMTS systems divides and uses a resource through various methods. Accordingly, ‘M_{γμ}’ may be changed according to a resource division method of each system.

For example, in a code division system such as the CDMA system, a resource is divided by a code and used. That is, when one terminal tries to connect to a code division system, a using resource is determined by a code be used by the corresponding terminal. Finally, ‘M_{γμ}’ is determined based on the quantity of codes using for transmitting data. Further, ‘M_{γμ}’ is determined based on a signal-to-noise ratio (SINR).

Further, in a wireless LAN (WLAN) system, in order to provide transmission opportunity, a random access method in which collision occurs is used and a time slot using for transmitting data is used as a resource. Finally, ‘M_{γμ}’ may be determined based on the quantity of time slots used for transmission. Further, ‘M_{γμ}’ may be determined based on the average transmission rate.

Further, in a multichannel system such as Wibro, because a resource is used as a sub-channel unit determined based on a time and a frequency, a resource in which a terminal should additionally use becomes a sub-channel. Finally, ‘M_{γμ}’ may be determined based on the quantity of sub-channels using for transmitting data. When the quantity of users increases, because a channel efficiency of a sub-channel is improved, a multi-channel system may be determined based on the quantity of users.

‘R_{req}’ indicates a sustainable service rate that should receive from a base station or a server in order to satisfy a service quality (QoS) condition of the user. The R_{req} is a value determined according to a service requested by each user. If a user wants a large capacity of service, because ‘R_{req}’ increases, a value of the cost increases. If a user wants a low capacity of service, because ‘R_{req}’ decreases, a value of the cost decreases.

A method of assigning a resource of a united system is described with reference to FIG. 5.

FIG. 5 is a flowchart illustrating a method of assigning a resource of a united system according to an exemplary embodiment of the present invention.

Referring to FIG. 5, in the method of assigning a resource of a united system according to an exemplary embodiment of the present invention, a cost function is determined using SNSI commonly used within the united system (S510).

The cost function is determined based on an amount M_{γμ} of surplus resources used when a predetermined terminal receives a service by connecting to a single system. Here, the amount M_{γμ} of surplus resources may be an amount of resources using when the terminal transmits unit data.

The cost function can be determined based on an average channel state S_{avg} within a single system and a channel state A_{cal} of a predetermined terminal within the single system. Here, the average channel state S_{avg} is determined based on a resource use rate γ of a system and a bandwidth efficiency μ of a system. The channel state A_{cal} of the terminal is defined by a ratio with an average channel state S_{avg}.

The cost function is determined based on a data rate R_{req} that should receive from a base station or a server in order to satisfy a service quality condition requested by the user.

Further, the cost function may be determined based on a cost Dᵣₑₛ per unit time for reducing latency and a latency request value L_{req} and may be also determined based on a total resource cost C_{BW}.

The amount M_{γμ} of surplus resources is determined according to a resource division method of a single system.

Next, resources are assigned based on the determined cost function (S520). As a value of the function cost decreases, a resource is assigned in a priority order.

The present invention may be also implemented with computer readable codes in a computer readable recording medium. The computer readable recording medium may include all kinds of recording devices in which data that can be read by a computer system are stored. The computer readable recording medium may include, for example a ROM, a RAM, a CD-ROM, a magnetic tape, a floppy disk, and an optical data storage device. In addition, the computer readable recording medium may also include implementations in the form of carrier waves (e.g. transmission via Internet). Further, the computer readable recording medium is distributed to a computer system connected to a network and the computer readable codes may be stored and executed therein in a distributed manner.

In a united system according to an exemplary embodiment of the present invention, in a state where different systems are integrally operated, a cost function is determined using SNSI and by assigning a resource based on the cost function, when integrally operating a different kind of system, a resource can be efficiently used. Furthermore, enlargement of a system capacity and user satisfaction can be improved.

Particularly, when a terminal is connected to any single system, in consideration of an amount of necessary surplus resources per unit data, and a channel state and a service quality condition of the terminal, by determining a cost function, a channel state of each system and user requirements can be fully reflected, thus a resource can be optimally distributed, and a performance of a service quality can be improved.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of assigning a resource of a united system in which a plurality of single systems are complexly operated, comprising:
determining a cost function using standard network state information commonly used within the united system; and
assigning a resource based on the cost function.

2. The method of claim 1, wherein the cost function is determined based on an amount of a surplus resource using when a predetermined terminal receives a service by connecting to a single system.

3. The method of claim 2, wherein the amount of a surplus resource is an amount of a resource using when the terminal transmits unit data.

4. The method of claim 2, wherein the amount of a surplus resource is determined according to a resource division method of the single system.

5. The method of claim 2, wherein the amount of a surplus resource is determined based on the quantity of codes using when transmitting data in a code division system.

6. The method of claim 2, wherein the amount of a surplus resource is determined based on the quantity of time slots using when transmitting data in a wireless LAN system.

7. The method of claim 2, wherein the amount of a surplus resource is determined based on the quantity of sub-channels using when transmitting data in a multi-channel system.

8. The method of claim 2, wherein the cost function is determined based on an average channel state within a single system and a channel state of a predetermined terminal within the single system.

9. The method of claim 8, wherein the average channel state is determined based on a resource use rate of the system and a bandwidth efficiency of the system.

10. The method of claim 9, wherein the resource use rate of the system is determined by a used resource amount to a total resource amount of the system; and
the bandwidth efficiency of the system is determined by a transmitted data rate to a total bandwidth of the system.

11. The method of claim 8, wherein the channel state of the terminal is defined by a ratio with the average channel state.

12. The method of claim 2, wherein the cost function is determined based on a data rate that should receive from a base station or a server in order to satisfy a service quality condition requested by a user.

13. The method of claim 2, wherein the cost function is determined based on a cost per unit time for reducing latency and a latency request value.

14. The method of claim 2, wherein the cost function is determined based on a total resource cost.

15. The method of claim 1, wherein as a value of the cost function decreases, the resource is preferentially assigned.

16. A method of assigning a resource of a united system in which a plurality of single systems are complexly operated, comprising:
determining standard network state information common used within the united system; and
assigning a resource based on the standard network state information.

17. The method of claim 16, wherein the standard network state information is determined based on a service quality and a cost function in each system.

18. The method of claim 16, wherein the standard network state information is a common index representing state information of each system and request information of each user.

19. A method of assigning a resource of a united system in which a plurality of single systems are complexly operated, comprising:
exchanging state information of each system and request information of each user; and
assigning a resource based on the state information and the request information.

20. The method of claim 19, wherein the state information of each system and the request information are standardized by commonly used standard network state information.
